(19) United States
(12) Patent Application Publication
(10) Pub. No.: US 2021/0124156 A1
(43) Pub. Date: Apr. 29, 2021

(54) OPTICAL SYSTEM, PROJECTION LENS, IMAGE PROJECTION APPARATUS AND IMAGE CAPTURING LENS

(71) Applicant: CANON KABUSHIKI KAISHA, Tokyo (JP)

(72) Inventor: Makoto TAKAHASHI, Tochigi (JP)

(21) Appl. No.: 17/078,339

(22) Filed: Oct. 23, 2020

(30) Foreign Application Priority Data
Oct. 29, 2019 (JP) 2019-195985

(51) Int. Cl. G02B 15/14

(52) U.S. Cl. CPC G02B 15/142

(57) ABSTRACT

The optical system includes in order from an enlargement conjugate side to a reduction conjugate side a first unit having a negative or positive refractive power, an aperture stop, and a second unit. At least one of the first and second units includes a negative lens, and when vn represents an Abbe number of the negative lens in a d-line, and dn/dtn represents a temperature coefficient of a refractive index of the negative lens, the optical system satisfies 10≤vn≤40 and dn/dtn<0.

### BACKGROUND OF THE INVENTION

### Field of the Invention

The present invention relates to an optical system used for a projection lens and an image capturing lens.

### Description of the Related Art

An optical system used for a projection lens of a projector (image projection apparatus) and used for an image capturing lens of a camera is required to be small in size and to have a high definition, and further to have little focus variation (resolution deterioration) due to temperature changes. Japanese Patent Laid-Open No. 2012-13982 discloses a projection lens having a temperature compensation function of performing focus control according to a temperature detected by a temperature sensor. Japanese Patent Laid-Open No. 2018-132565 discloses a projection lens having a temperature compensation function by a combination of glass materials of a plurality of positive lenses.

However, the projection lens disclosed in Japanese Patent Laid-Open No. 2012-13982 requires the temperature sensor and a control unit that performs the focus control, which complicates the configuration of the projection lens. Further, with the temperature compensation function only by the combination of glass materials as disclosed in Japanese Patent Laid-Open No. 2018-132565, it is difficult to obtain a sufficient temperature compensation effect.

### SUMMARY OF THE INVENTION

The present invention provides an optical system capable of providing a good temperature compensation effect while having a simple configuration.

The optical system according to an aspect of the present invention includes in order from an enlargement conjugate side to a reduction conjugate side a first unit having a negative or positive refractive power, an aperture stop, and a second unit. At least one of the first and second units includes a negative lens, and when vn represents an Abbe number of the negative lens in a d-line, and dn/dtn represents a temperature coefficient of a refractive index of the negative lens, the following conditions are satisfied:

10≤vn≤40

dn/dtn<0.

The present invention further provides as other aspects thereof a projection lens, an image projection apparatus and an image capturing lens each using the above optical system.

Further features of the present invention will become apparent from the following description of exemplary embodiments with reference to the attached drawings.

### BRIEF DESCRIPTION OF THE DRAWINGS

FIG. 1 is a sectional view of a projection optical system that is Embodiment 1 of the present invention.

FIG. 2 illustrates aberration diagrams of the projection optical system of Embodiment 1 at a wide-angle end.

FIG. 3 illustrates aberration diagrams of the projection optical system of Embodiment 1 at a telephoto end.

FIG. 4 is a sectional view of a projection optical system that is Embodiment 2 of the present invention.

FIG. 5 illustrates aberration diagrams of the projection optical system of Embodiment 2 at the wide-angle end.

FIG. 6 illustrates aberration diagrams of the projection optical system of Embodiment 2 at the telephoto end.

FIG. 7 is a sectional view of a projection optical system that is Embodiment 3 of the present invention.

FIG. 8 illustrates aberration diagrams of the projection optical system of Embodiment 3 at the wide-angle end.

FIG. 9 illustrates aberration diagrams of the projection optical system of Embodiment 3 at the telephoto end.

FIG. 10 is a sectional view of a projector that is Embodiment 4 of the present invention.

### DESCRIPTION OF THE EMBODIMENTS

Exemplary embodiments of the present invention will hereinafter be described with reference to the accompanying drawings.

The optical system of each embodiment is used as an optical system for a projection lens of a projector (image projection apparatus) and for an image capturing lens of a camera (image capturing apparatus).

In general, in order to reduce axial chromatic aberration and the like of an optical system to improve its optical performance, a positive lens made of a low dispersion and anomalous dispersion glass such as S-FPL51 is used near a diaphragm (aperture stop). Description will be made of a behavior of the positive lens when a temperature change occurs.

The low dispersion and anomalous dispersion glass has a negative temperature coefficient of a refractive index (dn/dt), so that a refractive power of the positive lens weakens when its temperature rises. As a result, an image plane (focal position) of the optical system moves in an over direction. Further, since the low dispersion and anomalous dispersion glass has a large absolute value of dn/dt, its influence is dominant in the entire optical system, and focus variation occurs in the over direction when the temperature rises, resulting in deterioration of resolution. Therefore, in each embodiment, description will be made of an optical system that achieves a high optical performance by using the low dispersion and anomalous dispersion glass. Further, description will be made of an optical system in which focus movement due to the temperature change (hereinafter referred to as “temperature focus variation”) is small.

Specifically, the optical system of each embodiment includes, in order from an enlargement conjugate side to a reduction conjugate side, a front unit (first lens unit) having a negative or positive refractive power, an aperture stop, and a rear unit (second unit) having a positive refractive power. In such an optical system, at least one of the front and rear units includes at least one negative lens satisfying following conditional expressions (1) and (2). Further, at least one of the front and rear units may include at least one positive lens satisfying following conditional expressions (3) and (4).

10≤vn≤40 (1)

dn/dtn<0 (2)

62≤vp≤110 (3)

0<(dn/dtp)/(dn/dtn) (4)

In conditional expressions (1) to (4), vn represents an Abbe number of the negative lens in a d-line (wavelength 587.6 nm), dn/dtn represents a temperature coefficient of a refractive index of the negative lens, vp represents is an Abbe number of the positive lens in the d-line, and dn/dtp represents a temperature coefficient of a refractive index of the positive lens.

Satisfying conditional expressions (1) and (2) makes it possible to improve color performance (performance relating color) of the optical system and realize a high quality of an image projected or captured through the optical system.

The Abbe number vn smaller than the lower limit of conditional expression (1) makes the dispersion of the negative lens too large, which makes it impossible to realize a good color performance. The Abbe number vn larger than the upper limit of conditional expression (1) makes the dispersion of the negative lens too small, which also makes it impossible to realize a good color performance.

It is more preferable to change conditional expression (1) to following conditional expression (1)′.

20≤vn≤40. (1)′

The temperature coefficient of the refractive index dn/dtn larger than the upper limit of conditional expression (2) makes the temperature focus variation too large, which makes it impossible to realize a good resolution performance.

It is more preferable to change conditional expression (2) to following conditional expression (2)′.

dn/dtn<−5×10⁻⁶. (2)′

Furthermore, using glass materials whose temperature coefficients of a refractive index have the same sign as materials of the negative and positive lenses so as to satisfy conditional expressions (3) and (4) enables cancelling out the temperature focus variations due to these lenses, that is, providing a temperature cancelling effect, which realizes a good resolution performance in the entire optical system.

Specifically, Embodiment 1 described later provides an example in which the glass material of the negative lens is S-NPH7 (dn/dt=−4.1×10⁻⁶), the glass material of the positive lens is S-FPL51 (dn/dt=−6.4×10⁻⁶), and these negative and positive lenses are cemented to each other to constitute a cemented lens. In Embodiment 1, when the temperature rises by 10° C., a focus movement amount due to the negative lens is −2.44 μm, and a focus movement amount due to the positive lens is 5.96 μm. Thus, the focus movements are cancelled out in the entire cemented lens.

The Abbe number vp smaller than the lower limit of conditional expression (3) makes the dispersion of the positive lens too large, which makes it impossible to realize a good color performance. The Abbe number vp larger than the upper limit of conditional expression (3) makes the dispersion of the positive lens too small, which also makes it impossible to realize a good color performance.

It is more preferable to change conditional expression (3) to following conditional expression (3)′.

68≤vp≤96 (3)′

The temperature coefficient of the refractive index dn/dtp larger than the upper limit of conditional expression (4) makes the temperature focus variation too large, which makes it impossible to realize a good resolution performance.

It is more preferable to change conditional expression (4) to following conditional expression (4)′.

0<(dn/dtp)/(dn/dtn)<70 (4)′

On the other hand, the low dispersion and anomalous dispersion glass has a large linear expansion coefficient, and thereby causes a large change in shape due to a temperature change. Therefore, it is difficult to cement a positive lens and a negative lens each made of a general glass material. For this reason, in each embodiment, it is desirable that the positive and negative lenses satisfy following conditional expression (5).

|αp−αn|×10⁷≤60 (5)

In conditional expression (5), αp represents a linear expansion coefficient of the positive lens, and an represents a linear expansion coefficient of the negative lens. Satisfying conditional expression (5) makes it possible to cement the positive and negative lens each made of the low dispersion and anomalous dispersion glass. A value of |αp−αn|×10⁷ larger than the upper limit of conditional expression (5) makes difference between linear expansions of the positive lens and the negative lens too large, which undesirably causes cracking or peeling. In Embodiment 1, the value of |αp−αn|×10⁷ is 22, which satisfies conditional expression (5), thereby realizing a compact optical system having a high optical performance.

It is more preferable to change conditional expression (5) to following conditional expression (5)′.

|αp−αn|×10⁷≤50 (5)′

Further, satisfying following conditional expression (6) enables more effectively reducing the temperature focus variation.

−70[φn/φp]/[(dn/dtn)/(dn/dtp)]>0 (6)

In conditional expression (6), φp represents a refractive power of the positive lens, and φn represents a refractive power of the negative lens. The refractive power is the reciprocal of a focal length.

Conditional expression (6) means that a ratio of the refractive powers of the positive and negative lenses is appropriately set with respect to the temperature coefficients of the refractive index of the positive and negative lenses. A value of [φn/φp]/[(dn/dtn)/(dn/dtp)] out of the range of conditional expression (6) makes difference between the temperature focus variations due to the positive and negative lenses too large, which makes it impossible to realize a high resolution optical system with little temperature focus variation.

It is more preferable to change conditional expression (6) to following conditional expressions (6)′ or (6)″.

−10>[φn/φp]/[(dn/dtn)/(dn/dtp)]>0 (6)′

−3≥[φn/φp]/[(dn/dtn)/(dn/dtp)]>0 (6)″

Moreover, using the negative lens that satisfies following conditional expression (7) enables further effectively reducing the temperature focus variation.

0≤Ln/L≤0.9 (7)

In conditional expression (7), L represents a total length of the optical system, and Ln represents a distance from a position of the aperture stop to an aperture stop-side surface of the negative lens. The position of the aperture stop is at or near a point where an optical axis of the optical system intersects with a principal ray of off-axis rays.

A value of Ln/L smaller than the lower limit of conditional expression (7) makes a temperature correction effect of the negative lens large, which makes the temperature focus variation too large. As a result, it becomes impossible to realize a good resolution performance. On the other hand, a value of Ln-L larger than the upper limit of conditional expression (7) makes the temperature correction effect of the negative lens small, which makes the temperature focus variation too large. As a result, it also becomes impossible to realize a good resolution performance.

In particular, when this optical system is used as the projection lens of the projector, a temperature rise in the vicinity of the aperture stop is large. Therefore, it is more preferable to satisfy, instead of conditional expression (7), following conditional expression (7)′ or (7)″

0.001≤Ln/L≤0.400 (7)′

0.001≤Ln/L≤0.100 (7)″

Further, in order to more appropriately set the refractive power of the negative lens, it is desirable to satisfy following conditional expressions (8) and (9).

−2≤φn/φp<0 (8)

−0.5≤φn/φ<0 (9)

A value of φn/φp out of the range of conditional expression (8) makes the refractive power of the negative lens large, which makes the temperature focus variation too large. As a result, it becomes impossible to realize a good resolution performance.

It is more preferable to change conditional expression (8) to following conditional expression (8)′.

−1.2≤φn/φp<0 (8)′

Similarly, a value of φn/φ out of the range of conditional expression (9) makes the refractive power of the negative lens large, which makes the temperature focus variation too large. As a result, it becomes impossible to realize a good resolution performance.

It is more preferable to change conditional expression (9) to following conditional expression (9)′.

−0.35≤φn/φ<0 (9)′

Moreover, in order to more appropriately set the temperature coefficients of the refractive index of the positive and negative lenses, it is desirable to satisfy following conditional expression (10).

−7≤[(dn/dtp)−(dn/dtn)]×10⁶≤5 (10)

A value of [(dn/dtp)−(dn/dtn)]×10⁶ smaller than the lower limit of conditional expression (10) makes a negative temperature correction effect large, which makes the temperature focus variation too large. Therefore, it becomes impossible to realize a good resolution performance. On the other hand, a value of [(dn/dtp)−(dn/dtn)]×10⁶ larger than the upper limit of conditional expression (10) makes a positive temperature correction effect small, which makes the temperature focus variation too large. Therefore, it becomes impossible to realize a good resolution performance.

It is more preferable to change conditional expression (10) to following conditional expression (10)′.

−7≤[(dn/dtp)−(dn/dtn)]×10⁶≤4 (10)′

Satisfying each of the above conditional expressions makes it possible to realize an optical system that can reduce the temperature focus variation while having a simple configuration.

The above configuration is the minimum one required as embodiments of the present invention, and hereinafter description will be made of Embodiment 1 to 3 as specific examples of the above configuration. The number and positions of the cemented lenses and the aperture stop, and the presence or absence of a zoom (magnification-variation) function and a focus function may be different from those in Embodiments 1 to 3.

### Embodiment 11

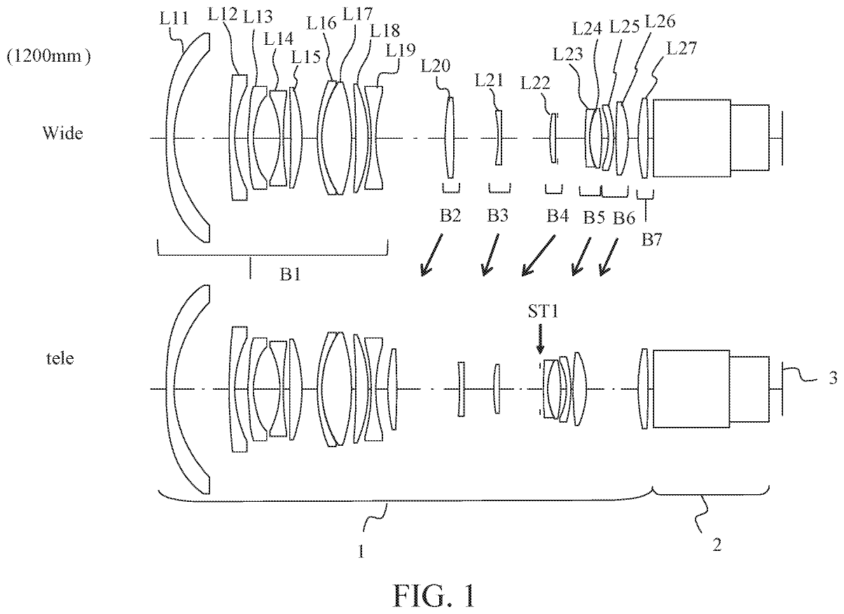

FIG. 1 illustrates a section of a projection optical system (projection distance 1200 mm) 1 of a first embodiment (Embodiment 1) at a wide-angle end (Wide) and a telephoto end (Tele). Reference symbols LII to L27 denote lenses numbered from an enlargement conjugate side to a reduction conjugate side. A prism 2 is disposed between the lens L27 and an image display element 3 displaying an original image for image projection. Reference symbol ST1 denotes an aperture stop.

The projection optical system 1 of this embodiment has a front unit including a first lens unit B1, a second lens unit B2, a third lens unit B3 and a fourth lens unit B4; the aperture stop STL; and a rear unit including a fifth lens unit B5, a sixth lens unit B6 and a seventh lens unit B7, which are arranged in order from the enlargement conjugate side to the reduction conjugate side. During zooming, the first and seventh lens units B1 and B7 are fixed (unmoved), and the second to sixth lens units B2 to B6 are moved. In the figure, the arrows attached to the second to sixth lens units B2 to B6 indicate movement loci of the second to sixth lens units B2 to B6 during zooming from the wide-angle end to the telephoto end.

In this embodiment, a cemented lens constituted by the negative and positive lenses L23 and L24 and included in the rear unit disposed further on the reduction conjugate side than the aperture stop ST has the temperature cancelling effect.

Specifically, the negative lens L23 is a lens made of a glass material of vn=23.9, dn/dtn=−4.1×10⁻⁶ and αn=109×10⁻⁷, and the positive lens L24 is a lens made of a glass material of vp=81.5, dn/dtp=−6.4×10⁻⁶ and αp=131×10⁻⁷.

Although the positive lens L22 included in the front unit and the negative lens L25 included in the rear unit do not constitute a cemented lens, they can provide the temperature cancelling effect as long as satisfying conditional expressions (1) to (4).

The values of conditional expressions (1) to (10) in this embodiment are collectively shown in (C) of Numerical Example 1. The projection optical system 1 of this embodiment satisfies all conditional expressions (1) to (10) (and (6)′, (6)″, (7)″ and (7)″).

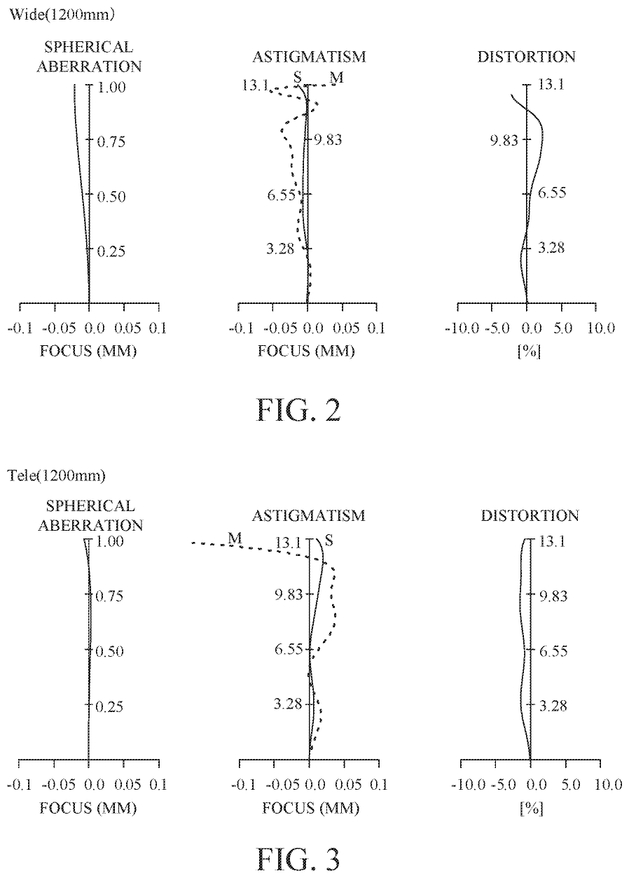

FIG. 2 is a longitudinal aberration diagram (projection distance 1200 mm) of the projection optical system 1 at the wide-angle end. FIG. 3 is a longitudinal aberration diagram (projection distance 1200 mm) of the projection optical system 1 at the telephoto end. FIGS. 2 and 3 show spherical aberration, astigmatism and distortion in the d-line (wavelength 587.6 nm). In the astigmatism diagram, the solid line S indicates a sagittal image surface, and the broken line M indicates a meridional image plane. These apply to longitudinal aberration diagrams of other embodiments described later.

### Embodiment 2

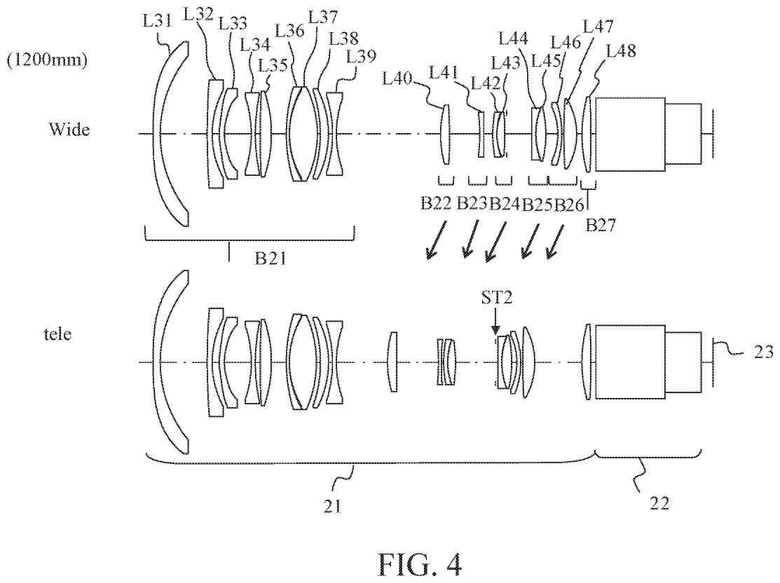

FIG. 4 illustrates a section of a projection optical system (projection distance 1200 mm) 21 of a second embodiment (Embodiment 2) at the wide-angle end and the telephoto end. Reference symbols L31 to L48 denote lenses numbered from the enlargement conjugate side to the reduction conjugate side. A prism 22 is disposed between the lens L48 and an image display element 23. Reference symbol ST2 denotes an aperture stop.

The projection optical system 21 of this embodiment has a front unit including a first lens unit B21, a second lens unit B22, a third lens unit B23 and a fourth lens unit B24; the aperture stop ST2; and a rear unit including a fifth lens unit B25, a sixth lens unit B26 and a seventh lens unit B27, which are arranged in order from the enlargement conjugate side to the reduction conjugate side. During zooming, the first and seventh lens units B21 and B27 are fixed (unmoved), and the second to sixth lens units B22 to B26 are moved. In the figure, the arrows attached to the second to sixth lens units B22 to B26 indicate movement loci of the second to sixth lens units B22 to B26 during zooming from the wide-angle end to the telephoto end.

In this embodiment, in addition to a cemented lens constituted by the negative and positive lenses L44 and L45 and included in the rear unit disposed further on the reduction conjugate side than the aperture stop ST2, a cemented lens constituted by the negative and positive lenses L42 and L43 and included in the front unit disposed further on the enlargement conjugate side than the aperture stop ST2 also has the temperature cancelling effect.

Specifically, the negative lens L44 is a lens made of a glass material of vn=23.9, dn/dtn=−4.1×10⁻⁶ and αn=109×10⁻⁷, and the positive lens L45 is a lens made of a glass material of vp=81.5, dn/dtp=−6.4×10⁻⁶ and αp=131×10⁻⁷.

The negative lens L42 is a lens made of a glass material of vn=37.2, dn/dtn=−0.1×10⁻⁶ and αn=85×10⁻⁷, and the positive lens L43 is a lens made of a glass material of vp=94.7, dn/dtp=−6.5×10⁻⁶ and αp=136×10⁻⁷.

The values of conditional expressions (1) to (10) in this embodiment are collectively shown in (C) of Numerical Example 2. The projection optical system 21 of this embodiment satisfies all conditional expressions (1) to (10). However, the cemented lens (L42 and L43) does not satisfy conditional expressions (6)′ and (6)″. In this case, the temperature cancelling effect is slightly reduced, but a degree of freedom in design is increased.

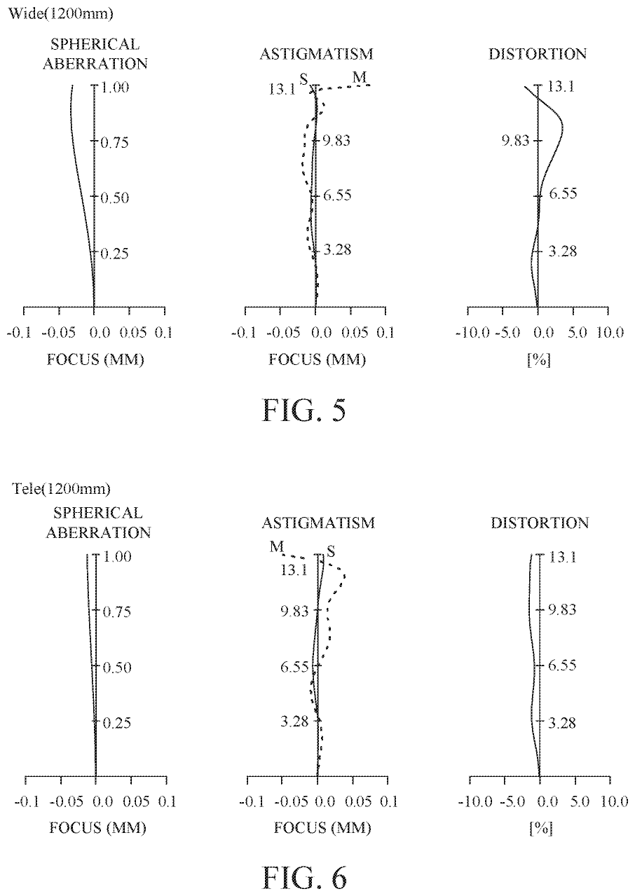

FIG. 5 is a longitudinal aberration diagram (projection distance 1200 mm) of the projection optical system 21 at the wide-angle end. FIG. 6 is a longitudinal aberration diagram (projection distance 1200 mm) of the projection optical system 21 at the telephoto end.

### Embodiment 31

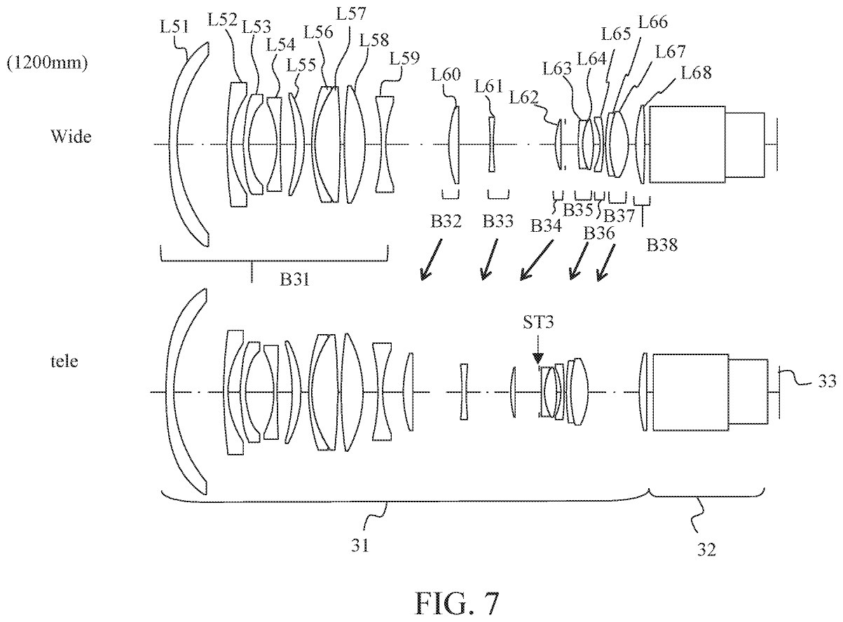

FIG. 7 illustrates a section of a projection optical system (projection distance 1200 mm) 31 of a third embodiment (Embodiment 3) at the wide-angle end and the telephoto end. Reference symbols L51 to L68 denote lenses numbered from the enlargement conjugate side to the reduction conjugate side. A prism 32 is disposed between the lens L68 and an image display element 33. Reference symbol ST3 denotes an aperture stop.

The projection optical system 31 of this embodiment has a front unit including a first lens unit B31, a second lens unit B32, a third lens unit B33 and a fourth lens unit B34; the aperture stop ST3; and a rear unit including a fifth lens unit B35, a sixth lens unit B36, a seventh lens unit B37 and an eighth lens unit B38, which are arranged in order from the enlargement conjugate side to the reduction conjugate side. During zooming, the first and eighth lens units B31 and B38 are fixed (unmoved), and the second to seventh lens units B32 to B37 are moved. In the figure, the arrows attached to the second to seventh lens units B32 to B37 indicate movement loci of the second to seventh lens units B32 to B37 during zooming from the wide-angle end to the telephoto end.

In this embodiment, in addition to a cemented lens constituted by the negative and positive lenses L63 and L64 and included in the rear unit disposed further on the reduction conjugate side than the aperture stop ST3, a cemented lens constituted by the negative and positive lenses L66 and L67 and disposed further on the reduction conjugate side than the cemented lens (L63 and L64), and a cemented lens constituted by the negative and positive lenses L56 and L57 and disposed further on the enlargement conjugate side than the aperture stop ST3 and away from the aperture stop ST3 also have the temperature cancelling effect.

Specifically, the negative lens L63 is a lens made of a glass material of vn=37.2, dn/dtn=−0.1×10⁻⁶ and αn=85×10⁻⁷, and the positive lens L64 is a lens made of a glass material of vp=81.5, dn/dtp=−6.4×10⁻⁶ and αp=131×10⁻⁷.

The negative lens L66 is a lens made of the glass material of vn=37.2, dn/dtn=−0.1×10⁻⁶ and αn=85×10⁻⁷, and the positive lens L67 is a lens made of a glass material of vp=70.2, dn/dtp=−0.5×10⁻⁶ and αp=90×10⁻⁷.

The negative lens L56 is a lens made of a glass material of vn=23.9, dn/dtn=−4.1×10⁻⁶ and αn=109×10⁻⁷, and the positive lens L57 is a lens made of the glass material of vp=70.2, dn/dtp=−0.5×10⁻⁶ and αp=90×10⁻⁷.

The values of conditional expressions (1) to (10) in this embodiment are collectively shown in (C) of Numerical Example 3. The projection optical system 31 of this embodiment satisfies all conditional expressions (1) to (10). However, the cemented lens (L63 and L64) does not satisfy conditional expressions (7)′ and (7)″. In this case, the temperature cancelling effect is slightly reduced, but a degree of freedom in design is increased.

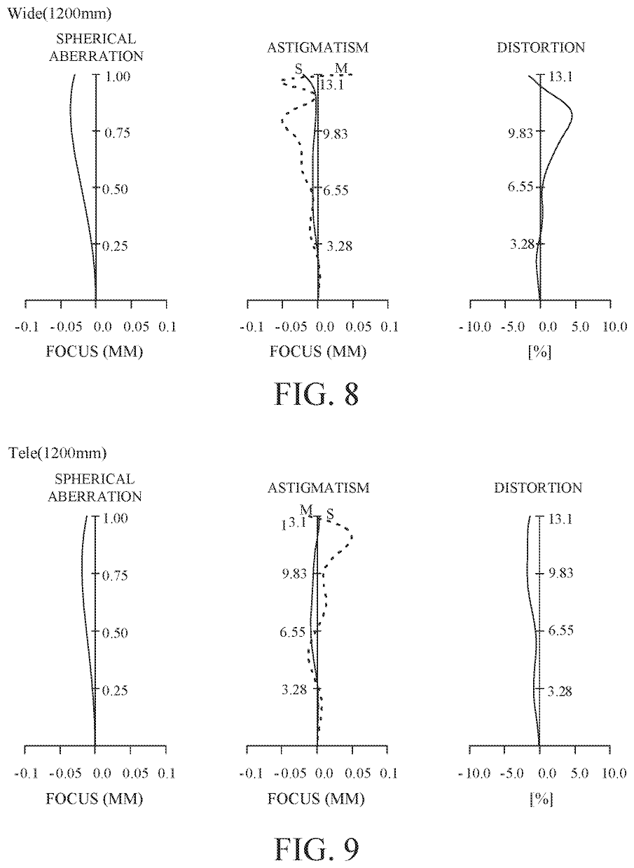

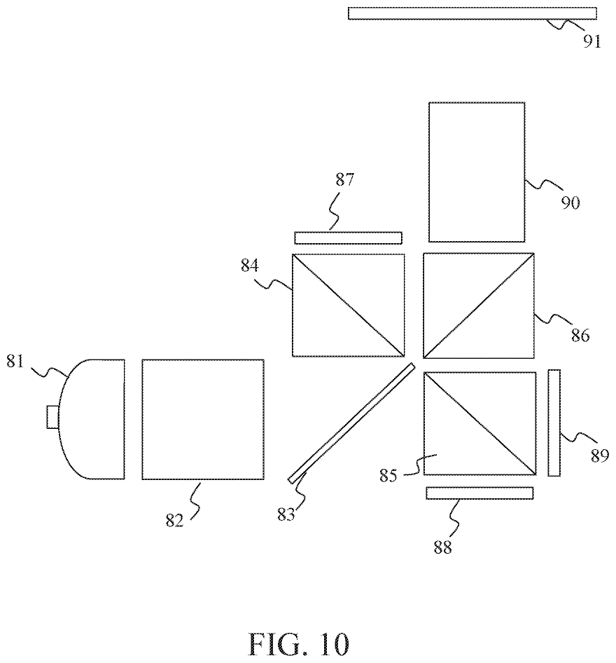

FIG. 8 is a longitudinal aberration diagram (projection distance 1200 mm) of the projection optical system 31 at the wide-angle end. FIG. 9 is a longitudinal aberration diagram (projection distance 1200 mm) of the projection optical system 31 at the telephoto end.

Numerical examples 1 to 3 corresponding to Embodiments 1 to 3 will be shown below. In each numerical example, (A) is a table shown a lens configuration. In the table, f represents a focal length, F an aperture ratio, ri a radius of curvature of the i-th surface from the enlargement conjugate side, and di a distance between the i-th surface and the (i+1)-th surface. Further, ni and vi respectively represent a refractive index in the d-line (587.6 nm) and an Abbe number of the i-th optical member from the enlargement conjugate side based on the d-line. The Abbe number vi based on the d-line is defined as vi=(Nd−1)/(NF−NC) where Nd, NF, and NC respectively represent refractive indices in the d-line, an F-line (486.1 nm) and a C-line (656.3 nm) of Fraunhofer lines. ST indicates the position of the aperture stop.

Moreover, BF represents a back focus (mm). The back focus is an air equivalent distance on an optical axis of the optical system from a final surface (most-reduction conjugate-side lens surface) to a paraxial image surface. A total lens length is a length obtained by adding the back focus to a distance on the optical axis from a front-most surface (most-enlargement conjugate-side lens surface) to the final surface of the optical system.

A surface marked with “*” on the left side means that the surface has an aspheric shape. When a coordinate in a direction of the optical axis is represented by z, a coordinate in a direction orthogonal to the optical axis is represented by y, a paraxial radius of curvature is represented by r, a conic constant is represented by k, and aspheric coefficients are represented by A to P shown in (B), the aspheric shape is expressed by the following expression. In the conic constant and aspheric coefficients, “±E-X” means×10^{-X}.

z(y)=(y²/ri)/{1+[1−(1+k)(y²/ri²)]^{1/2}}+Ay²+By³+Cy⁴+Dy⁵+Ey⁶+Fy⁷+Gy⁸+Hy⁹+Iy¹⁰+Jy¹¹+Ly¹²+My¹³+Ny¹⁴+Oy¹⁵+P¹⁶

### Numerical Example 1

(A) Lens configuration (mm)

| | Wide | Tele |
|---|---|---|
| f | 12.67 | 17.75 |
| F | 2.40 | 2.60 |
| Field angle (°) | 45.6 | 36.2 |
| Total lens length | 240.0 | |
| BF | 76.9 | |
| Zoom ratio | 1.40 | |

| | | | | |
|---|---|---|---|---|
| * | r1 = 329.70 | d1 = 4.00 | n1 = 1.773 | ν1 = 49.6 |
| | r2 = 63.04 | d2 = 27.18 | | |
| | r3 = 271.40 | d3 = 3.00 | n2 = 1.954 | ν2 = 32.3 |
| | r4 = 61.03 | d4 = 6.11 | | |
| * | r5 = 42.86 | d5 = 3.13 | n3 = 1.808 | ν3 = 40.6 |
| * | r6 = 30.08 | d6 = 12.96 | | |
| | r7 = −49.23 | d7 = 2.00 | n4 = 1.883 | ν4 = 40.8 |
| | r8 = 173.12 | d8 = 3.36 | | |
| | r9 = −613.43 | d9 = 5.71 | n5 = 1.893 | ν5 = 20.4 |
| | r10 = −73.99 | d10 = 7.99 | | |
| | r11 = 81.55 | d11 = 2.00 | n6 = 1.893 | ν6 = 20.4 |
| | r12 = 51.02 | d12 = 15.00 | n7 = 1.654 | ν7 = 39.7 |
| | r13 = −86.31 | d13 = 2.00 | | |
| | r14 = −287.56 | d14 = 6.10 | n8 = 1.639 | ν8 = 44.9 |
| | r15 = −70.19 | d15 = 1.50 | | |
| | r16 = −93.70 | d16 = 2.50 | n9 = 1.439 | ν9 = 94.7 |
| | r17 = 76.36 | d17 = variable | | |
| | r18 = 95.08 | d18 = 4.59 | n10 = 1.801 | ν10 = 35.0 |
| | r19 = −329.68 | d19 = variable | | |
| | r20 = −92.94 | d20 = 2.00 | n11 = 1.835 | ν11 = 42.7 |
| | r21 = 558.83 | d21 = variable | | |
| | r22 = 64.25 | d22 = 2.94 | n12 = 1.439 | ν12 = 94.7 |
| | r23 = −1400.54 | d23 = variable | | |
| ST | r24 = ∞ | d24 = variable | | |
| | r25 = 266.73 | d25 = 2.00 | n13 = 1.778 | ν13 = 23.9 |
| | r26 = 33.16 | d26 = 6.40 | n14 = 1.497 | ν14 = 81.5 |
| | r27 = −77.01 | d27 = variable | | |
| | r28 = −33.21 | d28 = 2.50 | n15 = 1.778 | ν15 = 23.9 |
| | r29 = −55.36 | d29 = 1.00 | | |
| | r30 = 173.24 | d30 = 6.52 | n16 = 1.439 | ν16 = 94.7 |
| | r31 = −46.19 | d31 = variable | | |
| | r32 = 87.28 | d32 = 5.05 | n17 = 1.893 | ν17 = 20.4 |
| | r33 = −282.29 | d33 = 3.00 | | |
| | r34 = ∞ | d34 = 38.00 | n18 = 1.516 | ν18 = 64.1 |
| | r35 = ∞ | d35 = 19.50 | n19 = 1.841 | ν19 = 24.6 |
| | r36 = ∞ | d36 = 6.49 | | |
| | r37 = ∞ | d37 = 9.87 | | |

In zooming (projection distance 1200 mm)

| Inter-unit distance | Wide | Tele |
|---|---|---|
| d17 | 34.17 | 5.88 |
| d19 | 21.79 | 31.35 |
| d21 | 23.83 | 14.82 |
| d23 | 1.00 | 20.38 |
| d24 | 13.83 | 1.50 |
| d27 | 3.35 | 2.85 |
| d31 | 4.50 | 25.70 |

### (B) Conic Constant and Aspheric Coefficients

| | K | A | B | C |
|---|---|---|---|---|
| r1 | 0 | 3.21274E−06 | −2.05717E−09 | 1.78078E−12 |
| r5 | 0 | −5.51937E−05 | 1.37695E−07 | −1.57463E−10 |
| r6 | 0 | −5.54661E−05 | 1.82186E−07 | −3.31986E−10 |
| | D | E | F | G |
| r1 | −1.13808E−15 | 4.90181E−19 | −1.21511E−22 | 1.32824E−26 |
| r5 | 8.76265E−14 | −2.32303E−17 | 0 | 0 |
| r6 | 4.82795E−13 | −3.43658E−16 | 0 | 0 |

### (C) Values of Conditional Expressions

| | |
|---|---|
| (1) | 23.9 |
| (2) | −4.1 × 10⁻⁶ |
| (3) | 81.5 |
| (4) | 1.56 |
| (5) | 22.0 |
| (6) | −1.5 |
| (7) | 0.058 |
| (8) | −0.98 |
| (9) | −0.26 |
| (10) | −2.3 |

### Reference Values

| | |
|---|---|
| dn/dtp*10\hat{ }6 | −6.4 |
| αn*10\hat{ }7 | 109.0 |
| αp*10\hat{ }7 | 131.0 |
| Ln(mm) | 13.8 |
| L(mm) | 240 |
| ϕ | 0.079 |
| ϕn | −0.021 |
| ϕp | 0.021 |

### Numerical Example 2

(A) Lens configuration (mm)

| | Wide | Tele |
|---|---|---|
| f | 12.66 | 17.74 |
| F | 2.40 | 2.60 |
| Field angle (°) | 45.6 | 36.3 |
| Total lens length | 240.0 | |
| BF | 71.7 | |
| Zoom ratio | 1.40 | |

| | | | | |
|---|---|---|---|---|
| * | r1 = 368.95 | d1 = 4.00 | n1 = 1.773 | ν1 = 49.6 |
| | r2 = 67.64 | d2 = 25.51 | | |
| | r3 = 326.87 | d3 = 3.00 | n2 = 1.954 | ν2 = 32.3 |
| | r4 = 53.93 | d4 = 3.84 | | |
| * | r5 = 34.85 | d5 = 2.72 | n3 = 1.808 | ν3 = 40.6 |
| * | r6 = 26.39 | d6 = 14.77 | | |
| | r7 = −59.13 | d7 = 2.00 | n4 = 1.804 | ν4 = 46.6 |
| | r8 = 102.51 | d8 = 2.98 | | |
| | r9 = 1108.44 | d9 = 5.92 | n5 = 1.893 | ν5 = 20.4 |
| | r10 = −77.47 | d10 = 8.12 | | |
| | r11 = 84.32 | d11 = 2.00 | n6 = 1.893 | ν6 = 20.4 |
| | r12 = 50.00 | d12 = 15.00 | n7 = 1.654 | ν7 = 39.7 |
| | r13 = −58.61 | d13 = 2.00 | | |
| | r14 = −68.22 | d14 = 4.29 | n8 = 1.639 | ν8 = 44.9 |
| | r15 = −52.49 | d15 = 2.00 | | |
| | r16 = −76.69 | d16 = 2.50 | n9 = 1.439 | ν9 = 94.7 |
| | r17 = 64.42 | d17 = variable | | |
| | r18 = 60.05 | d18 = 4.95 | n10 = 1.801 | ν10 = 35.0 |
| | r19 = −1313.06 | d19 = variable | | |
| | r20 = −103.79 | d20 = 2.00 | n11 = 1.835 | ν11 = 42.7 |
| | r21 = 657.89 | d21 = variable | | |
| | r22 = 68.40 | d22 = 2.00 | n12 = 1.834 | ν12 = 37.2 |
| | r23 = 31.56 | d23 = 4.25 | n13 = 1.439 | ν13 = 94.7 |
| | r24 = −119.72 | d24 = variable | | |
| ST | r25 = ∞ | d25 = variable | | |
| | r26 = 17896.80 | d26 = 2.00 | n14 = 1.778 | ν14 = 23.9 |
| | r27 = 38.27 | d27 = 5.47 | n15 = 1.497 | ν15 = 81.5 |
| | r28 = −80.48 | d28 = variable | | |
| | r29 = −32.06 | d29 = 2.00 | n16 = 1.778 | ν16 = 23.9 |
| | r30 = −49.14 | d30 = 1.00 | | |
| | r31 = 314.87 | d31 = 6.89 | n17 = 1.439 | ν17 = 94.7 |
| | r32 = −38.72 | d32 = variable | | |
| | r33 = 83.56 | d33 = 4.74 | n18 = 1.893 | ν18 = 20.4 |
| | r34 = −368.70 | d34 = 3.00 | | |
| | r35 = ∞ | d35 = 38.00 | n19 = 1.516 | ν19 = 64.1 |
| | r36 = ∞ | d36 = 19.50 | n20 = 1.841 | ν20 = 24.6 |
| | r37 = ∞ | d37 = 6.48 | | |

In zooming (projection distance 1200 mm)

| Inter-unit distance | Wide | Tele |
|---|---|---|
| d17 | 56.88 | 27.91 |
| d19 | 16.75 | 22.96 |
| d21 | 5.26 | 1.00 |
| d24 | 1.00 | 21.98 |
| d25 | 14.07 | 1.50 |
| d28 | 6.97 | 3.00 |
| d32 | 3.12 | 25.70 |

### (B) Conic Constant and Aspheric Coefficients

| | K | A | B | C |
|---|---|---|---|---|
| r1 | 0 | 3.39805E−06 | −2.16823E−09 | 1.82275E−12 |
| r5 | 0 | −5.61940E−05 | 1.36372E−07 | −1.58757E−10 |
| r6 | 0 | −5.63153E−05 | 1.78406E−07 | −3.29240E−10 |
| | D | E | F | G |
| r1 | −1.13505E−15 | 4.86018E−19 | −1.21690E−22 | 1.36567E−26 |
| r5 | 8.88109E−14 | −2.49587E−17 | 0 | 0 |
| r6 | 4.91758E−13 | −3.77127E−16 | 0 | 0 |

### (C) Values of Conditional Expressions

| | |
|---|---|
| (1) | 23.9 |
| (2) | −4.1 × 10⁻⁶ |
| (3) | 81.5 |
| (4) | 1.56 |
| (5) | 22.0 |
| (6) | −1.7 |
| (7) | 0.059 |
| (8) | −1.08 |
| (9) | −0.26 |
| (10) | −2.3 |

### Reference Values

| | |
|---|---|
| dn/dtp*10\hat{ }6 | −6.4 |
| αn*10\hat{ }7 | 109.0 |
| αp*10\hat{ }7 | 131.0 |
| Ln(mm) | 14.1 |
| L(mm) | 240 |
| ϕ | 0.079 |
| ϕn | −0.020 |
| ϕp | 0.019 |

### Numerical Example 3

(A) Lens configuration (mm)

| | Wide | Tele |
|---|---|---|
| f | 12.67 | 17.75 |
| F | 2.40 | 2.60 |
| Field angle (°) | 45.5 | 36.2 |
| Total lens length | 240.0 | |
| BF | 71.1 | |
| Zoom ratio | 1.40 | |

| | | | | |
|---|---|---|---|---|
| * | r1 = 290.93 | d1 = 4.00 | n1 = 1.773 | ν1 = 49.6 |
| | r2 = 72.07 | d2 = 25.00 | | |
| | r3 = 213.72 | d3 = 2.50 | n2 = 1.954 | ν2 = 32.3 |
| | r4 = 44.21 | d4 = 5.79 | | |
| * | r5 = 40.06 | d5 = 3.00 | n3 = 1.808 | ν3 = 40.6 |
| * | r6 = 29.86 | d6 = 13.95 | | |
| | r7 = −47.55 | d7 = 2.00 | n4 = 1.804 | ν4 = 46.6 |
| | r8 = 1306.84 | d8 = 7.44 | | |
| | r9 = −89.60 | d9 = 4.49 | n5 = 1.893 | ν5 = 20.4 |
| | r10 = −55.21 | d10 = 3.65 | | |
| | r11 = 82.39 | d11 = 2.00 | n6 = 1.778 | ν6 = 23.9 |
| | r12 = 50.87 | d12 = 12.71 | n7 = 1.487 | ν7 = 70.2 |
| | r13 = −298.72 | d13 = 2.00 | | |
| | r14 = 243.78 | d14 = 10.63 | n8 = 1.702 | ν8 = 41.2 |
| | r15 = −63.15 | d15 = 8.10 | | |
| | r16 = −95.21 | d16 = 2.00 | n9 = 1.439 | ν9 = 94.7 |
| | r17 = 55.20 | d17 = variable | | |
| | r18 = 60.05 | d18 = 4.95 | n10 = 1.801 | ν10 = 35.0 |
| | r19 = −1313.06 | d19 = variable | | |
| | r20 = −187.96 | d20 = 2.00 | n11 = 1.835 | ν11 = 42.7 |
| | r21 = 134.10 | d21 = variable | | |
| | r22 = 42.48 | d22 = 2.43 | n12 = 1.439 | ν12 = 94.7 |
| | r23 = 343.85 | d23 = variable | | |
| ST | r24 = ∞ | d24 = variable | | |
| | r25 = 168.56 | d25 = 2.00 | n13 = 1.834 | ν13 = 37.2 |
| | r26 = 28.33 | d26 = 5.85 | n14 = 1.497 | ν14 = 81.5 |
| | r27 = −44.75 | d27 = variable | | |
| | r28 = −28.54 | d28 = 1.50 | n15 = 1.778 | ν15 = 23.9 |
| | r29 = −127.78 | d29 = variable | | |
| | r30 = 88.91 | d30 = 2.00 | n16 = 1.834 | ν16 = 37.2 |
| | r31 = 53.44 | d31 = 9.10 | n17 = 1.487 | ν17 = 70.2 |
| | r32 = −36.17 | d32 = variable | | |
| | r33 = 78.84 | d33 = 4.15 | n18 = 1.893 | ν18 = 20.4 |
| | r34 = −450.94 | d34 = 3.00 | | |
| | r35 = ∞ | d35 = 38.00 | n19 = 1.516 | ν19 = 64.1 |
| | r36 = ∞ | d36 = 19.50 | n20 = 1.841 | ν20 = 24.6 |
| | r37 = ∞ | d37 = 6.47 | | |

In zooming (projection distance 1200 mm)

| Inter-unit distance | Wide | Tele |
|---|---|---|
| d17 | 32.18 | 10.65 |
| d19 | 15.60 | 24.66 |
| d21 | 31.25 | 22.33 |
| d23 | 2.17 | 12.00 |
| d24 | 6.85 | 1.00 |
| d27 | 3.06 | 2.34 |
| d29 | 1.50 | 1.12 |
| d32 | 4.17 | 25.70 |

### (B) Conic Constant and Aspheric Coefficients

| | K | A | B | C |
|---|---|---|---|---|
| r1 | 0 | 3.17823E−06 | −2.02593E−09 | 1.76789E−12 |
| r5 | 0 | −5.34993E−05 | 1.38596E−07 | −1.58148E−10 |
| r6 | 0 | −5.22232E−05 | 1.81508E−07 | −3.31534E−10 |
| | D | E | F | G |
| r1 | −1.13038E−15 | 4.88699E−19 | −1.21625E−22 | 1.33521E−26 |
| r5 | 8.52650E−14 | −2.20967E−17 | 0 | 0 |
| r6 | 5.11690E−13 | −3.85246E−16 | 0 | 0 |

### (C) Values of Conditional Expressions

| | |
|---|---|
| (1) | 37.2 |
| (2) | −0.1 × 10⁻⁶ |
| (3) | 81.5 |
| (4) | 64.00 |
| (5) | 46.0 |
| (6) | −56.0 |
| (7) | 0.029 |
| (8) | −0.88 |
| (9) | −0.31 |
| (10) | −6.3 |

### Reference Values

| | |
|---|---|
| dn/dtp*10\hat{ }6 | −6.4 |
| αn*10\hat{ }7 | 85.0 |
| αp*10\hat{ }7 | 131.0 |
| Ln(mm) | 6.8 |
| L(mm) | 240 |
| ϕ | 0.079 |
| ϕn | −0.024 |
| ϕp | 0.028 |

### Embodiment 4

FIG. 10 illustrates a configuration of an image projection apparatus (projector) that is a fourth embodiment (Embodiment 4) of the present invention. The projector includes a light source 81, an illumination optical system 82 that converts light from the light source 81 into illumination light having a specific polarization direction and having uniform brightness, a color separation optical system (a dichroic mirror 83 and polarization beam splitters 84 and 85) that separates the illumination light into three color lights of RGB, and reflective image display elements 87, 88 and 89 that modulate the three color lights according to an input image signal.

Further, the projector includes a color combination optical system (the polarization splitters 84 and 85 and a color combination prism 86) that combines the three color lights modulated by the image display elements 87, 88 and 89. The light combined by the color combination optical system is enlarged and projected onto a projection surface 91 such as a screen through a projection lens 90.

Using the projection optical system of any one of the above-described embodiments as an optical system of the projection lens 90 makes it possible to project a high-quality image with little temperature focus variation. The projection lens 90 may be an interchangeable lens that is detachably attachable to the projector.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-195985, filed on Oct. 29, 2019 which is hereby incorporated by reference herein in its entirety.

What is claimed is:

1. An optical system comprising in order from an enlargement conjugate side to a reduction conjugate side:
a first unit having a negative or positive refractive power;
an aperture stop; and
a second unit,
wherein at least one of the first and second units includes a negative lens, and
when vn represents an Abbe number of the negative lens in a d-line, and dn/dtn represents a temperature coefficient of a refractive index of the negative lens, the following conditions are satisfied:
10≤vn≤40
dn/dtn<0.

2. The optical system according to claim 1, wherein at least one of the first and second units includes a positive lens, and
when vp represents an Abbe number of the negative lens in the d-line, and dn/dtp represents a temperature coefficient of a refractive index of the positive lens, the following conditions are satisfied:
62≤vp≤110
0<(dn/dtp)/(dn/dtn).

3. The optical system according to claim 2, wherein, whenαp represents a linear expansion coefficient of the positive lens, and an represents a linear expansion coefficient of the negative lens, the following condition is satisfied:

|αp−αn|×10⁷≤60.

4. The optical system according to claim 2, wherein the positive and negative lenses constitute a cemented lens.

5. The optical system according to claim 2, wherein, when φp represents a refractive power of the positive lens, and φn represents a refractive power of the negative lens, the following condition is satisfied:
−70≥[φn/φp]/[(dn/dtn)/(dn/dtp)]>0.

6. The optical system according to claim 2, wherein, when φp represents a refractive power of the positive lens, and φn represents a refractive power of the negative lens, the following condition is satisfied:
−2≤φn/φp<0.

7. The optical system according to claim 2, wherein the following condition is satisfied:
−7≤[(dn/dtp)−(dn/dtn)]×10⁶≤5.

8. The optical system according to claim 1, wherein, when L represents a total length of the optical system, and Ln represents a distance from a position of the aperture stop to an aperture stop-side surface of the negative lens, the following condition is satisfied:
0<Ln/L≤0.9.

9. The optical system according to claim 1, wherein, when φn represents a refractive power of the negative lens, and φ represents a refractive power of the optical system, the following condition is satisfied:
−0.5≤φn/φ<0

10. The optical system according to claim 1, wherein at least a part of a plurality of lenses included in the first and second units moves to perform variation of magnification.

11. A projection lens using an optical system, the optical system comprising in order from an enlargement conjugate side to a reduction conjugate side:
a first unit having a negative or positive refractive power;
an aperture stop; and
a second unit,
wherein at least one of the first and second units includes a negative lens, and
when vn represents an Abbe number of the negative lens in a d-line, and dn/dtn represents a temperature coefficient of a refractive index of the negative lens, the following conditions are satisfied:
10≤vn≤40
dn/dtn<0.

12. An image projection apparatus using an optical system as a projection lens, the optical system comprising in order from an enlargement conjugate side to a reduction conjugate side:
a first unit having a negative or positive refractive power;
an aperture stop; and
a second unit,
wherein at least one of the first and second units includes a negative lens, and
when vn represents an Abbe number of the negative lens in a d-line, and dn/dtn represents a temperature coefficient of a refractive index of the negative lens, the following conditions are satisfied:
10≤vn≤40
dn/dtn<0.

13. An image capturing lens using the optical system according to claim 1 for image capturing.
